(19) United States
(12) Patent Application Publication
(10) Pub. No.: US 2021/0142625 A1
(43) Pub. Date: May 13, 2021

(54) REAL-TIME PEER-TO-PEER SPORTS PREDICTION PLATFORM

(71) Applicant: Simple Magic Software, LLC., Irvington, NY (US)

(72) Inventor: Yiftah FRECHTER, Irvington, NY (US)

(73) Assignee: Simple Magic Software, LLC.., Irvington, NY (US)

(21) Appl. No.: 16/679,962

(22) Filed: Nov. 11, 2019

(51) Int. Cl. G07F 17/32; G06Q 50/34

(52) U.S. Cl. CPC G07F 17/3288; G06Q 50/34

(57) ABSTRACT

A system and a method for pairing sports predictions in real-time or near-real-time. The method includes receiving a plurality of sports predictions submitted by a plurality of independent participants; pairing pairs of participants of the plurality of independent participants based on their respective sports predictions, wherein only one prediction of each pair of participants is true; monitoring data sources providing information on the sports predictions; and determining which prediction of each of the paired participants is true.

### TECHNICAL FIELD

The present disclosure relates generally to entertainment platforms and, specifically, to real-time peer-to-peer entertainment platforms that allow sports predictions.

### BACKGROUND

Sports prediction is the process of asserting a predicted outcome of a sporting match or various events therein. The prediction applied may be defined at odds predetermined based on previous sport performances or may be ad-hoc. Where participants agree to a prediction, trust may be employed to guarantee payment of the agreed reward on completion of the sporting event, or a third party may serve as an escrow. The predictions made between participants may be based on the overall outcome of a match, such as the final score, or smaller, discretized events, such as the number of points scored by one of the teams within a given period or the outcome of a given pass, play, penalty kick, and so on.

Currently, platforms exist which enable participants to predict the outcomes of sporting events while remote from both the event and from other participants. Platforms allowing remote sports predictions typically rely on a predetermined probability sheet specifying appropriate rewards for a given prediction. The probability sheet is predetermined by a central entity (“house”). The use of a predetermined probability sheet allows participants to challenge the “house's” predictions. The predetermined probability sheet may be drafted such that a limited number of combinations of predictions and rewards are available for each outcome. This method of prediction-sheet generation effectively employs a form of arbitrage whereby the “house,” or the controller of the probability sheet, profits from the predictions made, regardless of the outcome of the match. In addition to guaranteeing a house profit, platforms employing a predetermined probability sheet lack the capacity to pair participants, who would ordinarily agree to opposite sides of a prediction, with one another.

Platforms which enable peer-to-peer sports prediction pairings typically lack the capacity to match participants on predictions other than on the outcome of a match. The performance of individual players and teams during discrete periods within a match provides additional opportunities for prediction, and allowing participants to predict in-game performance fuels greater excitement and enjoyment for those watching the match. Examples of in-game metrics on which participants may wish to make a prediction include: a certain passing player's completed passes, a team's points scored in a given time period, or the outcome of a given play in the match. The application of real-time sports data to a prediction platform, configured to permit direct peer-to-peer predictions, presents a yet-unresolved user desire.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for managing peer-to-peer sports predictions. The method comprises receiving a plurality of sports predictions submitted by a plurality of independent participants; pairing pairs of participants of the plurality of independent participants based on their respective sports predictions, wherein only one prediction of each pair of participants is true; monitoring data sources providing information on the sports predictions; and determining which prediction of each of the paired participants is true.

In addition, certain embodiments disclosed herein include a non-transitory computer readable medium having stored thereon instructions for causing a processing circuitry to execute a process. The process comprises the steps of receiving a plurality of sports predictions submitted by a plurality of independent participants; pairing pairs of participants of the plurality of independent participants based on their respective sports predictions, wherein only one prediction of each pair of participants is true; monitoring data sources providing information on the sports predictions; and determining which prediction of each of the paired participant is true.

Certain embodiments disclosed herein also include a system for managing peer-to-peer sports predictions in real-time or near-real-time. The system comprises a processing circuitry; and a memory, the memory containing instructions that, when executed by the processing circuitry, configure the system to: receive a plurality of sports predictions submitted by a plurality of independent participants; pair pairs of participants of the plurality of independent participants based on their respective sports predictions, wherein only one prediction of each pair of participants is true; monitor data sources providing information on the sports predictions; and determine which prediction of each of the paired participant is true.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method of sorting predictions into queues according to an embodiment.

FIG. 3 illustrates the ordering of prediction queues based on outcome probability and prediction rewards according to an embodiment.

FIG. 4A illustrates the elimination of voidable prediction pairings through calculation of a spread and the pairing of predictions by probability and prediction reward rankings.

FIG. 4B illustrates the pairing of predictions in an embodiment according to a method of best fit.

FIG. 4C illustrates the pairing of predictions in an embodiment according to an investment matching method.

FIG. 5 is a flowchart illustrating a process of determining the winner of a prediction.

FIG. 6 is a schematic diagram of a schematic diagram of a hardware layer according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

FIG. 1 shows an example network diagram 100 utilized to describe the various disclosed embodiments for pairing sports predictions in real-time or near-real-time. As illustrated in FIG. 1, a prediction management platform (PMP) 120 is connected to a network 110 which also allows connection with a database 130, a plurality of user devices 140-1 through 140-N (hereinafter referred to individually as a user device and collectively as user devices 140, merely for simplicity purposes) and a plurality of data sources 150-1 through 150-M (hereinafter referred to individually as a data source 150 and collectively as data sources 150, merely for simplicity purposes).

The network 110 may be, but is not limited to, a wireless, cellular or wired network, a local area network (LAN), a wide area network (WAN), a metro area network (MAN), the Internet, the worldwide web (WWW), similar networks, and any combination thereof.

The plurality of user devices 140 may include, but is not limited to, a personal computer (PC), a personal digital assistant (PDA), a mobile phone, a smart phone, a tablet computer, a wearable computing device, or any other system for interacting with the PMP 120. In an example, the plurality of user devices 140 includes an agent or a software application for interacting with the PMP 120. For example, the agent or a software application may include a web browser or a dedicated application.

The plurality of data sources 150 may include systems providing media streams, such as real-time or near real-time broadcasting of the events including, but not limited to, sports events. The plurality of data sources 150 may also include services providing sports prediction information. One or more of the data sources 150 may include web sources providing information or statistics related to sports events.

In the example network diagram 100, the network 110 facilitates the transmission of prediction information between the plurality of user devices 140 and the PMP 120, as well as the transmission of live and historic sports feeds and data from the plurality of data sources 150 to the PMP 120.

In an embodiment, the PMP 120, is configured to receive, index, and process prediction data sent from the plurality of user devices 140, using both prediction data from other user devices 140, and sports feeds and data from the one or more data sources 150.

In a further embodiment, the PMP 120 is configured to manage predictions for events including, but not limited to, sports events among users of the plurality of user devices 140. That is, the plurality of user devices 140 are peers in the network that make and accept predictions with each other. For example, users of the plurality of user devices 140 may make a prediction with each other each regarding which team would win a sport match.

The predictions, according to an embodiment, are submitted to the PMP 120. A prediction may be made on a single statistic for specific team or player or a matchup between teams and players. For example, a prediction may be on a number of points that a particular baseball player can score during second half of the game. The prediction may be in formulated in a binary format. For example, the prediction may be presented as if a particular baseball player can score an exact number of points, more than the number of points, or less than the number of points. The answers to all such predictions are either YES or NO, i.e., binary.

In general terms, the binary prediction may be presented as “under” or “over” a certain score, “hit” or “miss”, “win” or “lost”, and so on.

In some example embodiments, predictions may be wagers or bets placed on a specific event, e.g., a sport event. The participants may be bettors. It should be noted that, such betting or gaming is performed among the bettors and the PMP 120 or any other entity does not act as a “house,” determining the chances (risks) or rewards associated with the betting. In an embodiment, the PMP 120 is configured to act as a matchmaker, pairing predictions between users based on the predictions' expected outcomes.

In an embodiment, the PMP 120 is configured to facilitate the exchange of predictions between external user devices 140. As the PMP 120 may be configured to facilitate the exchange of predictions between the plurality of user devices 140, such a configuration of the PMP 120 may allow participants to directly communicate predictions without the need for a “house” or a central system that controls the predictions and any rewards and probabilities associated with predictions. Furthermore, as the PMP 120 may be configured to receive and analyze sports data from the plurality of data sources 150, such a configuration of the PMP 120 may allow the automatic selection of a winner of a given prediction based on data received. Finally, as the PMP 120 may be configured to receive, archive, and analyze predictions and sports data, such a configuration of the PMP 120 may allow seamless user-to-user prediction exchange and transfer of rewards without the use of a “house.”

The management of predictions received from the users of the devices 140 is performed by the PMP 120 using a set of queues to match predictions of two or more users. In an embodiment, a user may not be aware of predictions by other users. Accordingly, the predictions of two or more users are matched when only one of the predictions can be true. When the predictions are over a spread of the statistics, the predictions are matched when spread is a positive number. This ensures a single winner in a gaming or betting embodiment.

For example, a user A submits a prediction that NY Giants would win a match against the NY Jets; and user B submits a prediction that NY Giants would lose a match against the NY Jets. The PMP 120 is configured to search all predictions and associate predictions that can facilitate a challenge (or a bet) between users. In an embodiment, the PMP 120 may be configured to receive, organize into queues, and pair predictions on a continuous basis before and during an event. In this example, user A is associated or matched to user B. As the prediction is binary, either user A or user B will correctly predict the outcome of the match.

The PMP 120 is further configured to associate or match users based on the investment and expected reward provided with each prediction. For example, if user A expects $100 for an investment of $10 if the prediction is true, and user B expects $5000 for an investment of $10 if the prediction is true, then these users cannot be matched. However, if their respective expected reward is substantially the same (e.g., up to a certain predefined threshold) the users are matched. In an embodiment, the PMP 120 is configured to alert users that their expected rewards cannot be matched and suggest a reward that can be matched. The various embodiments for matching among users' predictions are discussed below.

In an embodiment, the PMP 120 may be configured to create pairings of predictions which could not be matched on receipt. In an embodiment, the PMP 120 may be configured to dynamically re-weight reward-factor-based queue rankings, resulting in higher priorities for predictions which would ordinarily be of a lower rank. Further, in an embodiment, the PMP 120 may be configured to create pairings which could not be matched on receipt by using investment amounts not claimed from previous predictions to artificially generate predictions which may be paired with unpaired predictions received from users.

In a further embodiment, the PMP 120 may be configured to create paintings of predictions which could not be matched on receipt, using investment amounts not claimed from previous predictions to artificially generate predictions which may be paired with unpaired predictions received, giving preference to unpaired predictions created by users whose previous bets resulted in unclaimed investment amounts. In such an embodiment, the PMP 120 may be configured to artificially generate predictions using unclaimed investment amounts by first pairing artificial predictions with the predictions of users whose previous predictions resulted in unclaimed investments. Furthermore, the PMP 120 may be configured to refund some amount of an unclaimed investment to one or more users, with the amount refunded including, without limitation, a portion of the unclaimed investment, the entire unclaimed investment, and the like.

The database 130 may include prediction requests sent by the plurality of user devices 140, prediction queues, prediction results, predictions, and other information that allows the operation of the PMP 120. In an embodiment, the database is part of the PMP 120 or connected to the PMP 120. The database 130 may be configured to, without limitation, connect directly to the network system 110, connect directly to the PMP 120, or connect directly to both the network system 110 and the PMP 120.

The PMP 120 may be realized using one or more servers, which may be deployed in a cloud computing platform or data center. A server may be a physical machine or a virtual machine. The servers realizing the PMP 120 may be geographically distributed. An example structure of the PMP 120 is provided in FIG. 6.

FIG. 2 is an example flowchart 200 illustrating a method for sorting predictions into queues according to an embodiment. A queue may be any form of a data structure.

At S210, predictions are received from a plurality of user devices. Each received prediction may contain, without limitation, data identifying an event, such as a whole game or match, and an entity, such as a team or player of interest. Additionally, a received prediction may also contain, without limitation, a figure or statistic regarding a measurable outcome of play, such as the number of yards gained on a pass or the number of goals scored in the third period. A received prediction may also contain, without limitation, a position, such as whether the pass specified in the figure will be successful or whether the combined points at the end of the game will be over or under the value specified in the figure. Finally, the prediction received may include, without limitation, an investment amount, indicating a participant's interest in the prediction, and a reward value, reflecting the participant's view of the accuracy of the prediction.

In an embodiment, the prediction received at S210 may be received in formats including, but not limited to, completed form templates provided by the PMP 120, free text, recorded voice commands, and the like.

At S220, data identifying the prediction event and entity is isolated. The prediction event identified may be an entire sports match, identified by data including, but not limited to, the competing players, the date and time, and the teams' league. Additionally, the entity may be identified by factors including, but not limited to, team name, player name, or player number. In the embodiment, the predictions received contain sufficient data to enable identification of the prediction event for every prediction received.

For each prediction received, the data identifying the event, entity, figure, position, investment amount, and reward amount relevant to the prediction is isolated S220. Where the prediction is received as a form template provided by the PMP 120, the completed form will contain in its fields the indicated data, allowing the relevant data to be easily extracted and identified.

When the prediction is received in the form of free text or recorded voice input, the prediction is first structured before the data relevant to the event, entity, figure, position, investment amount, and reward amount can be identified. For free text, the string may be structured by textual analysis, parsing the string into segments matching the data required of a valid prediction using techniques such as, but not limited to, keyword matching, regular expressions, and machine learning. For a voice command recording, the recording may be structured first by conversion to text via voice-to-text methodologies, and subsequently parsed, as text, by the methods applicable to structure free text predictions. Therefore, the disclosed embodiments allow conversion of unstructured, or semi-structured, data into structured data. The structured data has a specific format allowing classifying prediction into queues.

At S230, it is determined whether a queue is available for the specified event and entity. The event queue may be any form of data and may include one or more entity queues for the event specified in the prediction. The entity queue may be any form of data and may include one or more figure queues for the entity and event specified in the prediction.

For example, if the isolation of a prediction's event and entity data indicates that the prediction's event concerns the first game of the World Series and the prediction's entity concerns team A's pitcher, it is first determined whether a queue exists for the first game of the World Series and whether a queue exists for team A's pitcher. If it is determined that either the event or entity queue does not exist, the necessary queues are created S240.

If it is determined that both the relevant event and entity queues exist, the prediction is sorted into the appropriate entity queue within the appropriate event queue S250. As an event queue may contain an entity queue and as an entity queue cannot exist without an event queue to which it belongs, a positive result for the appropriate entity queue necessitates the existence of the appropriate event queue.

At S240, event and entity queues are created. For each prediction, data specifying the respective event and entity are included and distinguished S220. For each event for which a prediction is received, a queue exists either by creation for a previous prediction, or by creation for the prediction in question. Each event queue may contain one or more entity queues, with each entity queue specifying either an entire team or a player on a team. Where a prediction is received which contains an event and entity for neither of which a queue exists, the event queue is created, and the entity queue is created within the event queue. Where a prediction is received, specifying an event for which a queue exists, but an entity for which no queue exists, an entity queue for the specified entity is created inside the existing specified event queue. As no entity queue can exist independent of an event queue, no valid prediction may refer to an entity queue which exists and an event queue which does not.

In an embodiment, after determining that the appropriate event and entity queues exist for the prediction, either by previous creation S230 or by instantiation upon receiving the prediction S240, the prediction is sorted into the appropriate event and entity queues S250. Using the data isolated from the prediction S220, the prediction is sorted into the appropriate entity queue within the appropriate event queue, with each prediction belonging to exactly one entity queue, each entity queue belonging to exactly one event queue, and each prediction, thus, belonging to exactly one event queue.

At S260, it is determined whether figure and position queues exist for the figure and position specified in the prediction. From the data isolated in the received prediction, the prediction's specified figure and position may be known. In the example, the figure is a data entry reflecting a measurable statistic or outcome of play, such as, but not limited to, a number of completed passes, a game score, or the outcome of a penalty goal attempt. In the example, the position is a binary data entry reflecting the predictor's view of the likelihood of the figure occurring for the given event and entity. The position may take one of several forms including, but not limited to, an over/under, wherein the participant indicates whether a numerical outcome, such as a number of points, will be over or under the amount detailed in the figure data, or a yes or no response to the outcome of a binary event, such as whether a player will make a given penalty goal attempt.

Furthermore, after isolating the data reflecting the prediction's figure and position S220, it is determined whether the queues for the specified figure and position exist S260. For a given prediction, previously sorted into appropriate event and entity queues S250, the prediction's figure requires a queue, assigned to the entity queue, which is, in turn, assigned to the event queue. Such a structure reflects the prediction's contents, namely that the participant is interested in a certain statistic, such as the final score, manifest as the figure queue, for a specified entity, such as team A, manifest in the entity queue, and for a given match, manifest in the event queue.

In addition, for a given prediction, previously sorted into appropriate event and entity queues, the prediction's position requires a queue, assigned to a figure queue. As the position cannot exist without a figure upon which the position depends, in no case can a position queue exist except as assigned to a figure queue. If either the appropriate figure queue or the appropriate position queue for the prediction does not exist, the necessary figure and position queues are created S260. If both the appropriate figure queue and position queue exist, the prediction is sorted into the appropriate queues S280. The determination of whether an appropriate queue exists may be made by methods including, but not limited to, comparison of the data values contained within the prediction with the data values or headers of the queues in existence.

In an embodiment, a figure queue, a set of position queues, or both, may be created to allow sorting of a given prediction S270. Based on the information isolated from the prediction S220, the appropriate figure queue and position queues may be identified. As a position queue necessarily resides within a figure queue, where a figure queue for the prediction does not exist, a figure queue and a pair of opposite position queues are created. Where a figure queue exists appropriate for the prediction, but a position queue does not, a pair of opposite position queues is created. In the example, the creation of one position queue necessitates the creation of another, opposite figure queue, representing the opposite binary position, such as yes or no or over or under.

After determining the existence of appropriate figure queues and position queues, either by inspection S260 or by the creation of the necessary figure queues and position queues S270, the prediction is sorted into the appropriate figure and position queues S280.

The prediction may be sorted into the appropriate queues by comparing the data extracted from the prediction S220 regarding figure and position with the queues' respective descriptions or headers. As each prediction may contain exactly one position and exactly one figure, each prediction may be sorted into exactly one position queue within exactly one figure queue. Furthermore, as each prediction may contain exactly one entity and exactly one event, each prediction, which belongs to one position queue, itself belonging to one figure queue, further belongs to exactly one entity queue which, in turn belongs to exactly one event queue. In the example, the application of this arrangement allows the queue configuration to reflect the prediction that a certain measurable outcome, given in the figure queue, will or will not occur, given by the position queue, for a given entity, given by the entity queue, within a given event, given by the event queue.

FIG. 3 illustrates the ordering of prediction queues 300 by probability score and reward score. In the example, the individual predictions 310 within a queue 300 are initially unordered, grouped only by prediction position. In the example, the PMP (120, FIG. 1) may be configured to sort the predictions within a queue by a score determined by dividing the absolute value of the individual predictions' 310 probability scores 320 by the individual predictions' reward scores.

In the example, the PMP may be configured to determine a prediction's probability score 320 as being equal to the number of standard deviations between that asserted prediction figure and the mean prediction FIG. 330 of all the predictions in the position queue.

In the example, the system may be configured to determine a prediction's reward score by dividing the prediction's investment amount by its reward amount, where the reward amount is necessarily greater than the investment amount and where both the reward amount and the investment amount are included with the prediction request at submission.

FIG. 4A illustrates the elimination of unmatchable prediction pairs by calculation of spread (noted as “spread in the drawing”), as well as the pairing of predictions 420, as ranked by score, within the queues 430. In an embodiment, predictions 420 from two queues 430 are compared to determine the spread, as calculated by subtracting the value which a participant predicts a statistic will be under (the “under” 440) from the value which a second participant predicts a statistic will be over (the “over” 450). In the example, the PMP 120 may be configured to eliminate as unpairable a set of predictions with a spread of zero or less. In the example, as a spread of zero or less would require an under 440 value greater than the corresponding over 450 value, allowing a pair with a spread of zero or less would create a situation, wherein both the over and under predictions could be met by the final outcome.

In the example, the PMP 120 may, optionally, reduce processing load, and thus increase speed, by sorting the “overs” 450 queue from highest to lowest, and sorting the “unders” 440 queue from lowest to highest. As the queues may be, optionally, presorted by a metric based on standard deviation, the configuration producing queues arranged thus may require a low-processing task of inverting one of the two queues. As comparing the “overs” 450 and “unders” 440 in this manner may indicate a first impermissible pair of predictions, continuing analysis of the spread for the remaining pairs may prove unnecessary, thereby improving computational efficiency.

In the example, the system may be configured to pair participants based on the queue-ordering ranking score, following elimination of unmatchable pairs by spread analysis. As the ranking score includes metrics of probability, reward, and investment amount, pairing participants with similar ranking scores will preserve participants' preferences for probability, reward, and investment amount.

FIG. 4B illustrates the pairing of predictions across queues according to a best fit method in an embodiment. In an embodiment, predictions 420 from two queues 430, ordered and ranked according to the embodiment in FIG. 4A, are paired according to a method of best fit. In an embodiment, a method of best fit pairs predictions 420 in counterpart queues 430 based on the predictions' ranks within the queues.

Specifically, according to the method of best fit, predictions are paired with the lowest-ranked prediction in the counterpart queue which creates a logically valid pairing, requiring a spread value greater than or equal to zero, and which has no unpaired higher-ranked predictions within its queue.

In the example shown in FIG. 4B, the pairing of all predictions but “over 3” and “under 13” is a valid pairing according to the method of best fit as each pair has a spread greater than or equal to zero and as only the lowest-ranked predictions in each queue are unpaired. Furthermore, in the example shown in FIG. 4b, the pairing of all predictions but “over 3” and “under 11” is invalid because the lower ranked “under 13” predictions cannot be paired, according to the best fit method, before the higher-ranked “under 11” is paired.

FIG. 4C illustrates the pairing of predictions across queues according to an investment matching method. In an embodiment, predictions 420 from two queues 430 are paired in such a fashion that the total investment amounts 460-1, 460-n, for all paired predictions in both queues equals the total reward amounts for each separate queue 470-1, 470-n. In the embodiment, prediction pairs which result in a spread computation of less than zero are impermissible, as in FIGS. 4A and 4B.

In the example shown in the FIG. 4C, a mismatch exists between the sum of the investment amounts and the reward amounts. Specifically, in the example shown in FIG. 4C, the total of the investment amounts from both queues 460-1, 460-n, equal to 13, is less than the total reward amount of 14 specified. In the example, a final score of 16 would satisfy the over conditions of the predictions of “over 15,” “over 13,” and “over 7.” As the total investment from both sides is 13, 7 from the “overs” and 6 from the “unders,” the amount necessary to satisfy the reward conditions for the winning predictions is greater than the amount available from user investment. To facilitate pairing in the case of a mismatch, one or more of several methods may be employed.

To facilitate pairing of predictions according to an investment matching method where a mismatch exists between the sum of the predictions' investment amounts and one or more of the queues' total reward amounts, the PMP 120 may, in an embodiment, provide users with notifications to update existing predictions or to place new predictions. In an embodiment, the PMP 120 may be configured to provide a notification to users in both queues 430 indicating a mismatch exists between investments and rewards and suggesting possible predictions to balance the mismatch. In an embodiment, the PMP 120 may be configured to further receive user inputs for new predictions or for the modification of existing predictions, until the investment and reward amounts for both queues are balanced. In an embodiment, the PMP 120 may be configured to prompt users to place additional predictions using rewards from previous successful predictions and may be configured to accept such predictions.

Furthermore, to facilitate pairing of predictions according to an investment matching method where a mismatch exists between the sum of the predictions' investment amounts and one or more of the queues' total reward amounts, the PMP 120 may, in an embodiment, split one or more predictions into smaller sub-predictions. In an embodiment, the PMP 120 may be configured to select, based on the queues' predictions' total investment value 460-1, 460-n and total reward value 470-1, 470-n, as well as the investment and reward values of individual predictions, one or more predictions to split. In an embodiment, the PMP 120 may be configured to balance investment-reward mismatches by automatically separating one or more predictions into smaller sub-predictions and adding the sub-predictions to the respective queues as necessary to balance investments and rewards. In an embodiment, the PMP may be configured to separate predictions while preserving the individual predictions' ratios of investment to reward. In an example, a prediction with an investment amount of 2 and a reward amount of 4, where the prediction's queue has a total investment amount of 7 and a total reward amount of 14, and where the counterpart queue has a total investment amount of 6 and a total reward amount of 12, may be split into two predictions, both having investment amounts of 1 and reward amounts of 2. In the example, by splitting the initial prediction into two sub-predictions, and then replacing the original prediction with one of the sub-predictions, the PMP may be configured to balance the investment to reward ratios and eliminate a mismatch.

FIG. 5 is an example flowchart 500 illustrating a method for the determination of a prediction winner based on sports data.

In the example, the process of identifying prediction winners necessarily begins with the organization of prediction queues S510. The organization of position queues 300 using scores reflecting risk and reward allows for the establishment of some degree of ranking within the queues.

At S520, the position pairs are subsequently matched to create paired predictions. In an example, prediction pairs, from two opposite position queues within the same figure queue, may be generated first by elimination of unpairable sets (for example, the set 400, FIG. 4A). Where two predictions in opposite position queues contain predictions which are not mutually exclusive, the two cannot be paired. For example, if two predictions for a team's score contain, in one prediction, a score greater than seven, and, in the other, a score less than fourteen, a possibility exists that both conditions may be satisfied if the score of the game falls between eight and thirteen and, as a result, the two predictions will be unpairable.

In an embodiment, unpairable prediction sets may be eliminated based on the predictions' specified base and reward amounts. In an embodiment, two predictions with disparate investment amounts or return amounts, as isolated from the prediction, may be deemed unmatchable. The determination of disproportionality may include, but is not limited to, evaluation of the percentage difference between the investment amounts of each prediction, the return amounts of each prediction, or both.

In an embodiment, the PMP 120 may be configured to hold unpairable predictions in a “pending” state. The PMP 120 may be configured to attempt to pair predictions held in a “pending” state on a continuous basis, at regular intervals, or upon the occurrence of some triggering event, such as the receipt of a new predictions. In an embodiment, the PMP 120 may be configured to notify a user that the user's prediction is unpairable. In a further embodiment, the PMP 120 may be configured to suggest prediction variants so that a user might modify their prediction so that it might be paired. In an embodiment, the PMP 120 may be configured to send notifications, including, but not limited to, messages and alerts, to a user device 140 in the event of an unpairable prediction.

At S530, after ranking and pairing the predictions within opposite position queues, data signaling the end of the event is received. This receipt may initiate the process of determining prediction winners. The data received, signaling the end of the event, may include, but is not limited to, live data feeds, sports statistics, or other data sources 150. The data, received from one or more of the plurality of data sources 150 (FIG. 1), may contain, but is not limited to, data describing the completion, and outcome, of a given event. For example, the data received may include information such as the final score of a match, broad statistics for a given play period, or the result of a specific penalty play instance. In the example, the data received for a given event necessarily contains sufficient information, separable from the data feed, to determine whether the specified event is ongoing or has concluded.

At S540, the location of relevant position queues facilitates the selection of one or more prediction winners. By matching the event-end data received S530 with the headers or contents of the event queues, the relevant event, entity, figure, and position queues may be identified.

At S550, a winning prediction is determined. In an embodiment, winners may be determined by iterating through the position queues relevant to the event, converting the positions into conditional queries, against which the data received from the data sources 150 may be compared. As each pair of predictions may have only one winner, the winner of each prediction pair must be one of the two predictions from the position queue analyzed.

At S560, after identifying the prediction winners, the participants are notified of the completion of the event (win or lose and the amount earned). The participants may be notified through the user devices, and may review the details of their predictions, as well as the outcome of the specific event, within the notification.

At S570, rewards are transferred to the winning participants. The reward may be a credit amount from the losing participants equal to the winning participants' reward value, as received in the prediction data. The reward may be in a form of tokens, coupons, currency, and the like.

As both the winning participant and losing participant submit their prediction participants with data specifying their base and reward amounts, these amounts are known in determination of a winner. In an embodiment, in order to prevent iniquity from occurring between two paired participants with different base and reward amounts, certain edge case results are defined. In the case that a winning participant's reward amount is greater than the losing participant's investment amount, the winning participant may take only the losing participant's investment amount from the losing participant. Additionally, in the event that the winning participant's reward amount is less than the losing participant's investment amount, the winning participant may take only the winning participant's reward amount from the losing participant. If the winning participant's reward amount equals the losing participant's investment amount, the winning participant may take that amount from the losing participant.

FIG. 6 is an example block diagram of the PMP 120 according to an embodiment. The PMP 120 includes a processing circuitry 610 coupled to a memory 620, a storage 630, and a network interface 640. In another embodiment, the components may be communicatively connected via a bus 650, such as PCIe bus.

The processing circuitry 610 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 620 may be volatile (e.g., RAM, etc.), non-volatile (e.g., ROM, flash memory, etc.), or a combination thereof. In one configuration, computer readable instructions to implement one or more embodiments disclosed herein may be stored in the memory 620.

In another embodiment, the memory 620 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, configure the processing circuitry 610 to perform the various processes described herein.

The storage 630 may be magnetic storage, optical storage, and the like, and may be realized, for example, as flash memory or other memory technology, CD-ROM, Digital Versatile Disks (DVDs), or any other medium which can be used to store the desired information.

The network interface 640 allows for communication over one or more networks, for example, to communicate with the user devices and data sources.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for managing peer-to-peer sports predictions, comprising:
receiving a plurality of sports predictions submitted by a plurality of independent participants;
pairing pairs of participants of the plurality of independent participants based on their respective sports predictions, wherein only one prediction of each pair of participants is true;
monitoring data sources providing information on the sports predictions; and
determining which prediction of each of the paired participants is true.

2. The method of claim 1, wherein pairing the pairs of participants further comprises:
sorting sports predictions into queues;
assessing risk and reward metrics for predictions received;
ranking the predictions based on risk and reward; and
pairing participants with similarly-ranked predictions for opposite outcomes of an event.

3. The method of claim 2, wherein each sports prediction designates at least an event, an entity, a figure, an investment amount, and a reward amount.

4. The method of claim 2, wherein sorting the sports predictions into queues further comprises:
separating predictions into ordered queues based on the predictions' positions, investment amounts, and reward amounts.

5. The method of claim 2, wherein assessing risk and reward metrics further comprises: dividing of an investment amount by a reward amount to obtain a reward score.

6. The method of claim 5, wherein assessing the risk and reward metrics further comprises:
creating a probability metric equal to absolute value of the number of standard deviations between the specified outcome and the mean of the specified outcomes for all specified outcomes within the prediction's queue.

7. The method of claim 1, wherein ranking the predictions based on risk and reward further comprises:
assigning each prediction within a queue a ranking score equal to the prediction's probability score divided by the prediction's reward score.

8. The method of claim 2, wherein pairing participants with similarly-ranked predictions further comprises:
excluding possible participant pairs where both predictions include non-mutually-exclusive specified predictions.

9. The method of claim 2, wherein pairing participants with similarly-ranked predictions further comprises:
creating a pair of participants based on the predictions with the highest ranking score in each queue.

10. The method of claim 2, wherein pairing participants with similarly ranked predictions further comprises:
removing paired participants from queues and includes pairing participants based on the highest ranking score remaining in each queue.

11. The method of claim 1, further comprising:
comparing paired predictions to sports data to determine a winner.

12. The method of claim 1, wherein the monitored information is received in real-time or near-real time.

13. A non-transitory computer readable medium having stored thereon instructions for causing a processing circuitry to execute a process, the process comprising:
receiving a plurality of sports predictions submitted by a plurality of independent participants;
pairing pairs of participants of the plurality of independent participants based on their respective sports predictions, wherein only one prediction of each pair of participants is true;
monitoring data sources providing information on the sports predictions; and
determining which prediction of each of the paired participant is true.

14. A system for managing peer-to-peer sports predictions, comprising:
a processing circuitry; and
a memory, the memory containing instructions that, when executed by the processing circuitry, configure the system to:
receive a plurality of sports predictions submitted by a plurality of independent participants;
pair pairs of participants of the plurality of independent participants based on their respective sports predictions, wherein only one prediction of each pair of participants is true;
monitor data sources providing information on the sports predictions; and
determine which prediction of each of the paired participant is true.

15. The system of claim 14, wherein the system is further configured to:
sort sports predictions into queues;
assess risk and reward metrics for predictions received;
rank the predictions based on risk and reward; and
pair participants with similarly-ranked predictions for opposite outcomes of an event.

16. The system of claim 15, wherein each sports prediction designates at least an event, an entity, a figure, an investment amount, and a reward amount.

17. The system of claim 15, wherein the system is further configured to:
separate predictions into ordered queues based on the predictions' positions, investment amounts, and reward amounts.

18. The system of claim 15, wherein the system is further configured to:
divide an investment amount by a reward amount to obtain a reward score to assess risk and reward metrics.

19. The system of claim 18, wherein the system is further configured to: create a probability metric equal to the absolute value of the number of standard deviations between the specified outcome and the mean of the specified outcomes for all specified outcomes within the prediction's queue.

20. The system of claim 14, wherein the system is further configured to:
assign each prediction within a queue a ranking score equal to the prediction's probability score divided by the prediction's reward score.

21. The system of claim 15, wherein the system is further configured to: exclude possible participant pairs where both predictions include non-mutually-exclusive specified predictions.

22. The system of claim 15, wherein the system is further configured to:
create a pair of participants based on the predictions with the highest-ranking score in each queue.

23. The system of claim 15, wherein the system is further configured to: remove paired participants from queues and includes pairing participants based on the highest-ranking score remaining in each queue.

24. The system of claim 14, wherein the system is further configured to:
compare paired predictions to sports data to determine a winner.

25. The system of claim 14, wherein the monitored information is received in real-time or near-real time.
